(19) United States
(12) Patent Application Publication
(10) Pub. No.: US 2014/0278756 A1
(43) Pub. Date: Sep. 18, 2014

(54) SYSTEM AND METHOD FOR ANALYZING AND PREDICTING THE IMPACTOF SOCIAL PROGRAMS

(71) Applicant: Mission Metrics, LLC, Chicago, IL (US)

(72) Inventor: Jason SAUL, Chicago, IL (US)

(73) Assignee: Mission Metrics, LLC, Chicago, IL (US)

(21) Appl. No.: 14/137,580

(22) Filed: Dec. 20, 2013

Related U.S. Application Data
(60) Provisional application No. 61/793,908, filed on Mar. 15, 2013.

(51) Int. Cl. G06Q 50/26; G06Q 30/02

(52) U.S. Cl. CPC G06Q 50/26; G06Q 30/0201
USPC 705/7.29

(57) ABSTRACT

The present disclosure includes a method, system, and computer program for analyzing the impact of social programs. The analysis of the impact of a social program may be facilitated by one or more application program units residing on a service provider's server. The service provider server may include an outcomes taxonomy, evidence base, data collection unit, data evaluation unit, program rating unit, metric calculations unit, and a benchmark database. The analysis may result in the generation of a program scorecard that includes a plurality of metrics that may estimate the likelihood of success of a social program. Each of the one or more metrics may be utilized in order to predict the impact of a social program.

### CROSS REFERENCE TO PRIOR APPLICATIONS

This application claims priority to and the benefit thereof from U.S. Provisional Patent Application No. 61/793,908, filed on Mar. 15, 2013, titled “Outcomes Taxonomy,” the entirety of which is hereby incorporated herein by reference.

### FIELD OF THE DISCLOSURE

The present disclosure relates to a system, a method, and a computer program that effectively analyzes the impact of social programs.

### BACKGROUND OF THE DISCLOSURE

Social programs may be implemented by one of the more than 1.4 million charities in America or one of many existing federal, state, or local government programs. A survey of known social programs provided by one of the foregoing entities will reveal tens of thousands of programs that purport to provide thousands of different outcomes. The conventional organization of social programs by subject matter, as opposed to by outcome, makes it difficult to identify a relevant set of social programs that may be implemented to produce a specific social benefit. The sheer amount of social programs, when coupled with a lack of adequate organization of social programs, makes it difficult to analyze and compare the efficiency of any given set of social programs. As a result, there is a long felt need for a method, a system, and a computer program that can effectively analyze the impact of a social program.

### SUMMARY OF THE DISCLOSURE

The present disclosure provides a system, a method, and a computer program that effectively analyzes the impact of social programs.

According to at least one aspect of the present disclosure, a method for analyzing a program is disclosed. The method may include receiving program information; identifying an outcome genome associated with the program information; comparing the received program information against the identified outcome genome, wherein the outcome genome includes a plurality of genes; and, generating raw ratings data, wherein the raw ratings data includes a plurality of ratings, wherein each rating in the plurality of ratings corresponds to a relationship between each of the plurality of genes and the received program information.

A gene may include a key characteristic associated with an outcome.

The relationship between a gene and the received program information may include a measure of the degree that the gene is expressed in the program information.

The received program information may comprise: one or more key characteristics associated with the program; and, one or more outcomes associated with the program.

The step of identifying an outcome genome may further comprise querying an impact genome database to retrieve each outcome genome corresponding to each of the one or more outcomes associated with the program.

The outcome genome may be associated with a level of success tag.

The level of success tag may provide an indication that the outcome genome is associated with one of a successful, moderately successful, or unsuccessful outcome.

The method may further comprise a step of feeding the raw ratings data into a metric calculations unit.

The method may further comprise a step of transforming the raw ratings data into one or more metrics by processing the raw ratings data in accordance with one or more scaling factors.

The one or more metrics may include at least one of an estimated number of outcomes, an estimated cost per outcome, or a confidence score.

In accordance with another aspect of the present disclosure, a system for analyzing a program is disclosed. The system comprises: a service that includes: a central processing unit, and a storage unit, wherein the storage unit further comprises: an outcomes taxonomy; an evidence base; and, an impact genome unit, wherein the impact genome unit further comprises: a receiving module that receives program information; a gene comparison module that compares the received program information to an outcome genome; and, a ratings module that generates raw ratings data, wherein the raw ratings data includes a plurality of ratings, wherein each rating in the plurality of ratings corresponds to a relationship between each of the plurality of genes and the received program.

A gene may include a key characteristic associated with an outcome.

The relationship between a gene and the received program information may include a measure of the degree that the gene is expressed in the program information.

The received program information may comprise: one or more key characteristics associated with the program; and, one or more outcomes associated with the program.

The system may further comprise: a querying unit that queries an impact genome database to retrieve each outcome genome corresponding to each of the one or more outcomes associated with the program.

The outcome genome may be associated with a level of success tag.

The level of success tag may provide an indication that the outcome genome is associated with one of a successful, moderately successful, or unsuccessful outcome.

The system may further comprise: a metric calculation unit that receives raw ratings data.

The system may further comprise: a metric calculation unit that transforms raw ratings data into one or more metrics by processing the raw ratings data in accordance with one or more scaling factors.

The one or more metrics may include at least one of an estimated number of outcomes, an estimated cost per outcome, or a confidence score.

Additional features, advantages, and aspects of the present disclosure may be set forth or apparent from consideration of the following detailed description, drawings, and claims. Moreover, it is to be understood that both the foregoing summary of the present disclosure and the following detailed description are exemplary and intended to provide further explanation without limiting the scope of the present disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a system that may facilitate the analysis of social programs in accordance with one aspect of the present disclosure.

FIG. 2 shows an example of a service provider server in accordance with one aspect of the present disclosure.

FIG. 3 shows an example of a method for analyzing social programs in accordance with at least one aspect of the present disclosure.

FIG. 4 shows an example of a program scorecard in accordance with one aspect of the present disclosure.

FIG. 5 shows an example of a method for using an evaluation rubric to rate a program in accordance with at least one aspect of the present disclosure.

FIG. 6 shows an example of a method for using an impact genome unit to rate social programs in accordance with at least one aspect of the present disclosure.

FIG. 7 shows an example of a method for updating an impact genome in accordance with at least one aspect of the present disclosure.

FIG. 8 shows an example of a system for mining a benchmark database in accordance with one aspect of the present disclosure.

FIG. 9 shows an example of a system for facilitating an outcomes marketplace in accordance with one aspect of the present disclosure.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples provided herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

An “entity,” as used in this disclosure means, but is not limited to, among other things, e.g., one or more of an individual, a group of individuals, a for-profit organization, a non-profit organization, a local government agency, a state government agency, a federal government agency, a sole proprietorship, a general partnership, a limited liability partnership, a corporation, a limited liability corporation, or the like.

A “computer,” as used in this disclosure means, but is not limited to, among other things, e.g., any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a tablet computer, a smart phone, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “client,” as used in this disclosure means, but is not limited to, among other things, e.g., any individual that desires to avail themselves of a service that is being offered by a service provider, except where the term “client” refers to a device such as, for example, a computer in a client-server architecture as made clear by the context within which the term is used. A client may refer to an individual, an entity, an individual associated with an entity, an entity's computer, an individual associated with an entity that is using an end-user, client-side computer, or the like.

A “server,” as used in this disclosure means, but is not limited to, among other things, e.g., any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation.

A “database as used in this disclosure means, but is not limited to, among other things, e.g., any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure means, but is not limited to, among other things, e.g., a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, among other things, e.g., at least one of a local area network (LAN), a wide area network (WAN), a storage area network (SAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

A “service provider,” as used in this disclosure means, but is not limited to, among other things, e.g., any entity that offers a service that one or more clients may avail. A service provider may include, e.g., an individual, an entity that considers and/or implements a program as contemplated herein including, but not limited, e.g., a social program. A service provider may be associated with one or more service provider staff.

“Service provider staff” or “service provider staff member,” as used in this disclosure means, but is not limited to, among other things, e.g., any one or more individuals that may be associated with a service provider. For example, service provider staff may include, e.g., any individual that is an employee, an agent, or a servant of the service provider. Alternatively (or additionally), service provider staff may include any individual, including an independent contractor of a service provider. Service provider staff may include, e.g., one or more experts in a particular field that may be used to obtain and analyze data associated with a social program.

An “individual,” as used in this disclosure means, but is not limited to, among other things, e.g., a human, an expert system, artificially intelligent software (e.g., fuzzy logic, neural networks, Bayesian classifiers, centralized agents, decentralized agents, or the like), a fully automated, robotic entity, or a plurality of fully automated, networked, robotic entities.

A “program,” as used in this disclosure means, but is not limited to, among other things, e.g., any activity, service, event, plan, process, series of one or more steps, or the like that may be considered and/or utilized by a person, organization, or other entity. A program may be considered and/or utilized for the purpose of, e.g., performing a particular task, increasing efficiency, achieving a specific outcome, or any other reason that may lead an entity to consider, implement, or change a program.

A “social program,” as used in this disclosure means, but is not limited to, among other things, e.g., any program that may be considered and/or utilized by an entity for the purpose of, among other things, e.g., providing guidance, assistance, benefits, or the like to another entity. A social program may include, e.g., a program that is implemented for the purpose of, among other things, e.g., providing guidance, assistance, benefits, or the like to a community of individuals.

“Mining” or “data mining,” as used in this disclosure means, but is not limited to, among other things, e.g., the process of examining data stored in a database. Examining data in a database may include, e.g., querying a database, identifying relationships between data stored in a database, identifying trends in a related set of data, the use of one or more artificial intelligence algorithms to facilitate the analysis of data stored in a database, or the like.

“Knowledge base,” as used in this disclosure means, but is not limited to, among other things, e.g., an organized repository of information. A knowledge base may refer to, e.g., a single organized repository of information that may be associated with a single topic. Alternatively, or in addition, a knowledge base may refer to, e.g., a repository that includes a plurality of individual knowledge bases, wherein each individual knowledge base is associated with a particular topic.

The terms “include,” “including,” “comprise,” “comprising” and variations thereof, as used in this disclosure, means “including, but not limited to, among other things” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure means, but is not limited to, among other things, e.g., any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., tens of, hundreds of, or thousands of) memory caches on multiple (e.g., tens of, hundreds of, or thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

FIG. 1 shows an example of a system 100 that may be implemented to facilitate an analysis of social programs in accordance with one aspect of the present disclosure. System 100 may include, e.g., a client-side, end user, service provider staff computer 110, a client-side, end user, client computer 120, a network 130, a communication link 140, a server 150, and a database 160 (or databases 160(1) to 160(z) (where z is a positive, non-zero integer)). System 100 may analyze social programs by facilitating the performance of one or more methods steps including, e.g., the method steps set forth in method 500, 600, or 700 as depicted in FIGS. 5, 6, and/or 7, and further described herein below.

While system 100 may facilitate the analysis of social programs, it is contemplated that the present disclosure need not be so limited. For example, it is contemplated that system 100 may also facilitate the analysis of any program considered and/or implemented by any entity. For example, system 100 may facilitate the analysis of the efficiency of a process for manufacturing a particular object such as, e.g., an automobile. Furthermore, system 100 may also facilitate the analysis of any entity itself. For example, in instances where the entity is a corporation, system 100 may analyze, among other things, e.g., the corporation's operating costs. However, e.g., in instances where the entity is an individual, system 100 may analyze, among other things, e.g., the individual's job performance. System 100 may analyze programs and entities by facilitating the execution of the concepts and principles embodied within one or more method steps described by the present disclosure including, e.g., one or more of the steps set forth in method 500, 600, or 700 as depicted in FIGS. 5, 6, and/or 7, and further described hereinbelow. Accordingly, while the present disclosure may be described in the context of the analysis of social programs, it will be readily apparent to those skilled in the art that, in light of the present disclosure, system 100 may be utilized to facilitate the analysis of any program, any entity, or object.

Network 130 and communication links 140 may work together to facilitate a connection between a service provider staff computer 110, a client computer 120, server 150, and/or database 160. Specifically, for example, server 150 and database(s) 160 may be connected to each other and/or network 130 via a communication link 140. Each of the service provider staff computers 110 and/or each of the client computer(s) 120 may be coupled to network 130 via communication links 140. Service provider staff computer(s) 110 and/or client computer(s) 120 may include, e.g., a computer used by a human individual(s). Alternatively, or in addition, service provider staff computer(s) 110 and/or client computer(s) 120 may include one or more of a variety of types of automated devices, such as, for example, a robot, robotic hardware, an automated actuator, and/or the like.

Server 150 may include one or more servers that may house a service provider's software application units, software storage applications, and/or computer algorithms that may facilitate execution of the service provider's core data processing activities (may be referred to herein as software applications). A service provider's core data processing activities may include, e.g., the input of data associated with a program or entity, storage of data associated with a program or entity, access to and/or modification of data associated with a program or entity, the mining of data associated with a program or entity, and/or the execution of software applications to facilitate each of the foregoing activities. Such core data processing activities may require server 150 to access database(s) 160.

Database(s) 160 may store data including, among other things, files, data structures, objects, metadata, records, information, methods, procedures, applications, or the like that may be associated with, and/or correspond to, a program and/or an entity. The data may describe, or otherwise be associated with, a program or an entity that may be analyzed, or otherwise evaluated, by system 100 and include, e.g., descriptions, attributes, genes, genomes, ratings, evaluations, scorecards, client profiles, various research models, or the like. Alternatively, or in addition, server 150 and/or database(s) 160 may also include one or more of the outcomes taxonomy, evidence base, data collection unit, data evaluation unit, program rating unit, metric calculations unit, benchmark database, and/or the outcomes marketplace.

Server 150 may include database(s) 160. In addition, or alternatively, one or more portions of database(s) 160 may be maintained externally to server 150. Server 150 and/or database(s) 160 may each be located at a single geographic location. Alternatively, server 150 and/or database 160 may include components that may be distributed amongst any one or more of a plurality of disparate geographic locations, so long as server 150 and database(s) 160 may be sufficiently configured to facilitate each respective core data processing activity that may be requested by service provider staff computer 110 and/or client computer 120.

Service provider staff computer 110 may include one or more end user, client-side computers 110(1) to 110(x) (where x is a positive, non-zero integer) (hereinafter “service provider staff computers”). A service provider staff member may utilize a service provider staff computer 110 to access server 150 via network 130 and a communication link 140 in order to perform one or more core data processing activities that may include populating, storing, accessing, modifying, manipulating and/or mining data that resides in database(s) 160. The performance of these core data processing activities may include the service provider staff member initiating and/or executing tasks that may include, e.g., interaction with an outcomes taxonomy (e.g., 253, shown in FIG. 2), an evidence base (e.g., 254, shown in FIG. 2), a data collection unit (e.g., 255, shown in FIG. 2), a data evaluation unit (e.g., 256, shown in FIG. 2), a program rating unit (e.g., 257, shown in FIG. 2), a metric calculations unit (e.g., 258, shown in FIG. 2), and/or a benchmark database (e.g., 259, shown in FIG. 2) to facilitate, or otherwise support, among other things, e.g., the analysis or evaluation of a program or entity. Alternatively, or in addition, e.g., the service provider staff member may utilize a service provider staff computer 110 to access server 150 via a network 130 and a communication link 140 in order to perform one or more core data processing activities that may include populating, storing, accessing, modifying, manipulating and/or mining data that resides in database(s) 160 in order to, among other things, e.g., interact with the outcomes marketplace in order to facilitate, or otherwise support, among other things, e.g., the bidding on outcomes, the buying of outcomes, the selling of outcomes, the investment in outcomes, the trading of outcomes, or the like. Access to server 150 may be facilitated by a user interface (not shown) that may be accessible via a service provider staff computer 110. The user interface (not shown) may include, e.g., a graphical user interface, an input/output (JO) interface (not shown), a transceiver (not shown), a modulator-demodulator (MODEM) (not shown), and the like.

Client computer 110 may include one or more end user, client-side computers 120(1) to 120(y) (where y is a positive, non-zero integer) (hereinafter “client computers”). A client may utilize a client computer 120 to access server 150 via the network 130 and the communication link 140 in order to perform one or more core data processing activities that may include populating, storing, accessing, modifying, manipulating and/or mining data that resides in database(s) 160. The performance of these core data processing activities may include the client initiating and/or executing tasks that may include, e.g., interaction with the outcomes taxonomy, evidence base, data collection unit, data evaluation unit, program rating unit, metric calculations unit, and/or the benchmark database to facilitate, or otherwise support, among other things, e.g., the analysis or evaluation of a program or entity. Alternatively, or in addition, the client may utilize a client computer 120 to access server 150 via a network 130 and a communication link 140 in order to perform one or more core data processing activities that may include populating, storing, accessing, modifying, manipulating and/or mining data that resides in database(s) 160 in order to, among other things, e.g., interact with the outcomes marketplace in order to facilitate, or otherwise support, among other things, e.g., the bidding on outcomes, the buying of outcomes, the selling of outcomes, the investment in outcomes, the trading of outcomes, or the like. Access to server 150 may be facilitated by a user interface (not shown) that may be accessible via a client computer 110. The user interface (not shown) may include, among other things, e.g., a graphical user interface.

The client's access to server 150 may be facilitated by a web application (not shown) that may be accessible via client computer 120. The web application may be hosted by server 150 or a third party server that may facilitate the hosting of web applications. The web application may be browser based and provide a means to authenticate the client's identity including, e.g., the use of a login, password, security questions, security images, and/or the like as is known in the art. Alternatively, or in addition, the client's access to server 150 via the web application may be encrypted using any of a variety of encryption algorithms known in the art such as, e.g., secure socket layer, transport layer security, public keys, private keys, session keys, and/or the like as is known in the art. In accordance with, or in addition to, the core data processing activities described herein, the web application may facilitate data collection, data analysis, communication between the client and the service provider staff member (e.g., email, instant messenger, video chat, message boards, or the like), and/or report presentation. Alternatively, or in addition, the web application may facilitate the mining of data on server 150 such as, e.g., the benchmark database. Alternatively, or in addition, the web application may facilitate interaction with an outcomes marketplace in order to mine, or otherwise access, upload, or modify, data associated with outcomes, bid on outcomes, buy outcomes, sell outcomes, invest in outcomes, trade outcomes, and/or the like. Any data that is uploaded, or otherwise submitted, by the client via the web application may be received by a data collection unit.

Clients may utilize the web application to manage a client profile that may be maintained by server 150. The client profile may provide an organized grouping of programs and/or entities that the client has asked the service provider to analyze. The organized grouping of programs and/or entities may be configured to receive the client's selection of a particular program or entity associated with the client's profile. In response to the client's selection of a specific program or entity, the web application may access server 150, query database(s) 160, retrieve detailed data associated with the selected program or entity, return the retrieved data, and then display the retrieved data on a user interface associated with the web application. The detailed data may include, among other things, e.g., the initial data associated with the client's program or entity that was uploaded by the client, the status of the service provider's analysis of the selected program or entity, notes associated with the analysis of the selected program or entity compiled by the service provider staff, the detailed evaluation rubric associated with the selected program or entity, one or more outcome genomes, one or more program genomes of related programs, the raw ratings data associated with one or more attributes of an evaluation rubric that may be associated with the selected program or entity, the raw ratings data of a program in accordance with a particular outcome genome, the results of the service provider's analysis of the selected program or entity including one or more calculated metrics, a scorecard associated with the selected program or entity, or the like.

The foregoing description of a web application in accordance with one aspect of the present disclosure has been set forth primarily with respect to the use of the web application by a client. However, the present disclosure is not so limited. Instead, for example, the web application may also be accessible by a service provider staff member via a service provider staff computer in order to perform any of the core data processing activities set forth herein. In addition, the server provider staff member may utilize the web application in the same manner that a client may utilize the web application, as described herein. As a result, it would be readily apparent to those skilled in the art that there should not be any limitation placed on the use of the web application based solely upon the fact that a particular client-side, end user is a client or a service provider staff member. Instead, any individual that utilizes an end user, client-side computer 120 may also utilize the web application in the same manner that the client is described to use the web application, herein.

In addition, the foregoing description of a web application, and any other web application described herein, should not be limited to browser based web applications. Instead, the web application of the present disclosure may include, e.g., any executable application hosted on a client or service provider's computer that may facilitate operation of the present disclosure in a non-browser based computing environment.

FIG. 2 shows an example of a service provider server 250 in accordance with one aspect of the present disclosure. Service provider server 250 (hereinafter server 250) may be substantially the same as or similar to server 150 (FIG. 1). Server 250 may include, e.g., a central processing unit 251 and a storage unit 252. Storage unit 252 may include storage space that may be associated with at least a portion of database(s) 160 (FIG. 1). Alternatively, e.g., storage unit 252 may be storage space that is provided in addition to database(s) 160. Storage unit 252 may include an outcomes taxonomy 253, an evidence base 254, a data collection unit 255, a data evaluation unit 256, a program rating unit 257, a metric calculations unit 258, and/or a benchmark database 259.

Outcomes taxonomy 253 may include a classification system that facilitates a structured organization of program outcomes. Program outcomes may include, e.g., social program outcomes (hereinafter “social outcomes”). The structured organization of program outcomes may include, e.g., a hierarchical listing of program outcomes for a known subset of programs at any given point in time. Accordingly, any given outcomes taxonomy that may exist at a certain point in time such as, e.g., outcomes taxonomy 253, may provide a snapshot of the entire range of possible program outcomes that may result from the planned execution and/or implementation of each of a known subset of existing programs. Outcomes taxonomy 253 may be periodically updated to account for the identification of new, or previously unknown, program outcomes that may result from the discovery of new, or previously unknown, programs.

The structured organization of program outcomes provided by outcomes taxonomy 253 may, e.g., provide a mechanism that allows the level of success of social programs to be measured. After server 250 receives program data associated with a program, a service provider staff member may traverse one or more branches of outcomes taxonomy 253 in order to identify a subset of specific outcomes that the program associated with the program data may provide.

The identified subset of outcomes may then be, e.g., utilized by the system 100 in order to direct the analysis of a program. Outcomes taxonomy 253 may direct the analysis of a program by providing valuable information such as, e.g., an identified subset of outcomes, that may be used to identify a range of different strategies (e.g., different programs) for arriving at each of the identified subset of outcomes. As a result, outcomes taxonomy 253 may provide a baseline from which different programs such as, e.g., social programs, may be compared and measured.

The process of building outcomes taxonomy 253 may begin by first analyzing each program in the subset of known programs to identify the outcome(s) associated with each program. Outcomes that a program may provide may be identified by analyzing, among other things, e.g., the key characteristics associated with a program. Key characteristics may include, e.g., program attributes, proven success factors, real-life approach(es) to implementing the program, the measured impact on each of the programs' intended beneficiaries, or the like. Alternatively, or in addition, a key characteristic may be described as including, e.g., any identifiable attribute that correlates to the successful production of a particular outcome from an outcomes taxonomy.

In accordance with one aspect of the present disclosure, outcomes taxonomy 253 may be designed, e.g., to classify a plurality of social outcomes. Social outcome(s) associated with a program may include, e.g., the benefit(s) that the social program may provide to society. Social outcomes may include, among other things, e.g., improving access to healthcare, raising awareness of breast cancer, improving graduation rates, improving literacy, creating jobs, creating affordable housing, reducing the number of stray animals, reducing air pollution, or the like. Next, each social outcome may be analyzed in order to identify a particular program type that may be associated with each social outcome. Program types that a social program may be associated with may be determined by analyzing, among other things, e.g., key characteristics or any other attribute that may be associated with a social program. Program types may include broad categories including, e.g., health, education, human services, public benefit, arts and culture, education, animal welfare, environment, youth development, or the like. After a program type is identified for a particular social outcome, the social outcome may become, e.g., tagged, or otherwise associated, with the program type and stored in a database such as, e.g., database 160. Performing the foregoing analysis for each social program in the subset of known social programs may create a first hierarchical layer of outcomes taxonomy 253. The first hierarchical layer of outcomes taxonomy 253 may be stored in a database, such as, e.g., database(s) 160, thereby creating a library of social outcomes that includes, e.g., a plurality of social outcome records. Each social outcome record may include, e.g., a social outcome and a particular program type.

In accordance with one aspect of the present disclosure, outcomes taxonomy 253 may include a plurality of hierarchical layers wherein each hierarchical layer may identify a particular subset of social outcomes that may be associated with each overarching category. Additional hierarchical layers of outcomes taxonomy 253 may be created utilizing program sub-types. Each program type may be associated with one or more program sub-types. For example, the program type “education” may be associated with one or more program sub-types such as, e.g., elementary education, secondary education, post-secondary education, extracurricular school sports, or the like.

The process for adding an additional hierarchical layer to outcomes taxonomy 253 may begin, e.g., after each social outcome has been associated with a particular program type. Next, each social outcome may be further analyzed within the context of a particular program type in order to identify a particular program sub-type that may be associated with each social outcome. When it has been established that a social outcome is associated with, e.g., the program type “education,” the social outcome may be further analyzed to determine whether the social outcome may be associated with one or more of the elementary education sub-types including, e.g., the secondary education sub-type, the post-secondary education sub-type, the extracurricular school sports sub-type, or any other sub-type that may be associated with the education program type. Program sub-types that a social program may be associated with may be determined by analyzing, among other things, e.g., key characteristics or any other attribute that may be associated with a social program. After a program sub-type is determined for a particular social outcome, the social outcome may be become, e.g., tagged, or otherwise associated, with the program sub-type and stored in a database such as, e.g., database 160. Performing the foregoing analysis for each social outcome may create a second hierarchical layer of outcomes taxonomy 253. The second hierarchical layer of outcomes taxonomy 253 may be stored in a database, such as, e.g., database(s) 160, in a manner similar to the storage of the first hierarchical layer of outcomes taxonomy 253, as described hereinabove. When outcomes taxonomy 253 includes a second hierarchical layer, each social outcome record may include, e.g., a social outcome, a particular program type, and a particular program sub-type.

However, the foregoing description of a single layer outcomes taxonomy or a double layer outcomes taxonomy should not be interpreted in a manner that places any limitations on the present disclosure. The outcomes taxonomy 253 may have any number of hierarchical layers. As a result, it will be readily apparent to those skilled in the art in light of the present disclosure that additional hierarchical layers may be added by, e.g., applying the concepts and principles that were described hereinabove to add first and second hierarchical layers to outcomes taxonomy 253. This may include the identification of, e.g., a program sub-sub-type that may be associated with a particular social program. Each additional layer may result in smaller subsets of related social outcomes that may be identified by a particular branch of outcomes taxonomy 253.

Outcomes taxonomy 253 may be generated by a service provider staff member, including, e.g., an expert system as noted earlier. The expert system, which may include artificial intelligence, may be trained by a service provider staff member to generate and/or update an outcome taxonomy. An expert system may be trained, e.g., by analyzing the historical decisions made by the service provider staff member when generating an outcomes taxonomy, and adjusting adaptive (and/or non-adaptive) weights as is known by those skilled in the art.

After outcomes taxonomy 253 is established, further analysis and/or processing of outcome taxonomy 253 may occur in order to standardize the outcomes associated with outcome taxonomy 253. Standardizing the outcomes associated with outcomes taxonomy 253 may result, e.g., in a reduction of the number of potential outcomes that may be used to compare and analyze social programs. For example, a service provider staff member may mine the library of social outcomes. Data mining may include, e.g., operations to eliminate duplicate, or otherwise redundant, outcomes. For example, it may be determined that the separate outcomes of improving student achievement, student performance, and academic achievement may all be generally equivalent and reduce that group of outcomes to a single outcome that includes, e.g., improving student achievement. Alternatively, or in addition, such data mining operations may also identify duplicate, or redundant, outcomes by, e.g., removing geography types and/or beneficiary types. For example, student achievement for African-America youth in Chicago may be identified as a duplicate, or otherwise redundant, outcome for the social outcome referred to as, e.g., improving student achievement. Alternatively, or in addition, such data mining operations may separate metrics such as, e.g., test scores, from outcomes such as, e.g., student achievement, in order to more precisely identify the social outcome of a particular social program.

An iterative process that may include the performance of one or more data mining operations, such as, e.g., those data mining operations specified herein, and the review and evaluation of the results of data mining operations, may facilitate the resolution of tens of thousands of social programs down to a significantly smaller number of standard social outcomes. Accordingly, received program data may be compared to a standardized outcomes taxonomy in order to identify a subset of one or more standardized outcomes that may be associated with the program data.

Once the outcomes taxonomy 253 has been created, the outcomes taxonomy may be periodically updated to reflect any new information that may be identified. Such new information may include, e.g., new programs, new outcomes, new program types, new program sub-types, or the like. As a result, the outcomes taxonomy 253 need not be a static classification system. Instead, the outcomes taxonomy may dynamically grow, expand, and evolve as new information is received (or obtained) by system 100.

Evidence base 254 may include, e.g., a database(s) that houses a knowledge base that may be used to facilitate the analysis of a social program. The knowledge base 254 may include, e.g., a meta-evaluation of existing social program information. Existing social program information may include, e.g., academic literature, scientific studies, government studies, or the like that may describe one or more aspects of an existing social program. An existing social program may be, e.g., a social program that has already been implemented whose functionality and results have been studied, evaluated, and/or documented. Alternatively, or in addition, an existing social program may include, e.g., a planned or theorized social program whose intended functionality and intended results have been studied, evaluated, and/or documented. Such existing social program information may be referred to as a model program.

The meta-evaluation of existing social program information may include, e.g., one or more key characteristics associated with a social program. The key characteristics of the social program may include, e.g., program attributes, proven success factors, real-life approaches to implementing the program, the measured impact on each of the programs intended beneficiaries, or the like. The meta-evaluation may be obtained by, e.g., analyzing existing social program information and extracting key characteristics associated with a social program.

Accordingly, a knowledge base maintained by evidence base 254 may include data in a variety of different forms including, e.g., a pre-analyzed form and an analyzed form. Data in pre-analyzed form may include, e.g., volumes of existing social program information such as, e.g., academic literature, scientific studies, government studies, or the like. Data in analyzed form may include, e.g., key characteristics of a social program that may have been extracted from one or more of the volumes of existing social program information in evidence base 254 in pre-analyzed form.

Evidence base 254 may include a single knowledge base that may be associated with a particular social program. There may be a one-to-one correspondence between a knowledge base and a particular social program. However, the present disclosure is not so limited. Instead, the evidence base 254 may include, e.g., a knowledge base that may be associated with a plurality of social programs. For instance, there may be a one-to-many correspondence between a knowledge base and a plurality of social programs. Such a knowledge base may be particularly beneficial in order to, e.g., generate a knowledge base of a plurality of related programs that may be capable of producing the same or similar social outcome.

The evidence base 254 may be built after received (or otherwise obtained) social program data has been evaluated in light of outcomes taxonomy 253 in order to identify a subset of relevant outcomes. Building evidence base 254 after a social program has been evaluated in light of outcomes taxonomy 253 may provide the benefit of utilizing the subset of outcomes identified using outcomes taxonomy 254 to direct the scope of the data that may be obtained in order to build evidence base 254. Alternatively (or additionally), the evidence 254 may be built at any time including before, during, or after the evaluation of a social program in light of an outcomes taxonomy 253.

Evidence base 254 may be populated with key characteristics in one or more of plurality of different ways. For example, a service provider staff may obtain a batch of existing social program information. The batch of existing social program information may be identified, e.g., based on a received set of outcomes. Service provider staff may then analyze the received batch of existing social program information in order to determine the subset of information that may be stored in evidence base 254. After analyzing the obtained batch of existing social program information, the service provider staff may, e.g., determine that the entire batch of received existing social program information may be stored in evidence base 254. The service provider staff may review the received existing social program information and strategically extract a subset of key characteristics that may be associated with a social program described by a batch of existing social program information. Service provider staff may utilize one or more automated tools to perform a search of one or more data sources containing existing social program information in order to identify and extract the most relevant subset of key characteristics that may be associated with a social program. One or more data clusters may be populated, e.g., using the information that the service provider staff member has determined should be stored in evidence base 254. The data clusters may then be used to facilitate the analysis of a social program.

A computer algorithm running on, e.g., server 150, such as, e.g., a web crawler, a web spider, or the like, as is known by those skilled in the art, may obtain existing social program information via one or more sources that may be accessible via a network 130. The computer algorithm may be configured to receive an input of one or more outcomes. The computer algorithm may obtain one or more keywords associated with the received outcomes. The computer algorithm may scan a plurality of data sources that may be accessible over the network 130. The step of scanning a plurality of data sources may include the application of one or more pattern matching techniques known to one skilled in the art. Alternatively, or in addition, the step of scanning a plurality of data sources may include identifying each network resource accessible via network 130, which may include one or more keywords associated with the received outcomes. A network resource may include, e.g., a web page, document, file, record or other data. The computer algorithm may retrieve and store a copy of each identified network resource in evidence base 254 for later review in order to determine the relevance of each retrieved network resource. The later review may be performed by, e.g., a service provider staff member to extract relevant information that may be used to populate one or more data clusters associated with evidence base 254. The data clusters may then be used to facilitate the analysis of a social program.

The computer algorithm running, e.g., on server 150, may be configured to generate a search query. The computer algorithm may transmit the search query to one or more databases that may be accessible over the network 130. In response to the query, the computer algorithm may receive one or more network resources that satisfy the query. The received network resources may be stored in evidence base 254 for later review to determine the relevance of each retrieved network resource. The later review may be performed by, e.g., a service provider staff member to extract relevant information that may be used to populate one or more data clusters associated with evidence base 254. The data clusters may then be used to facilitate the analysis of a social program.

As part of the review by a service provider staff member, the system may be trained to extract key characteristics from an identified network resource. For example, the system may be trained by analyzing the historical decisions made by a service provider staff member when analyzing identified network resources. The extracted key characteristics may be used to populate one or more data clusters associated with evidence base 254. The data clusters may be used to facilitate the analysis of a social program.

Evidence base 254 may organize the information that comprises the knowledge base using, e.g., a plurality of one or more data clusters. Data clusters may include, e.g., any conceptual grouping of information that has been retrieved (or otherwise obtained) in association with one or more existing social programs. The information may include, e.g., key characteristics that have been extracted from existing social program information. Data clusters may organize data utilizing any conceptual data structure including, e.g., records, columns, tables, arrays, lists, trees, graphs, hashes, custom data structures, or the like. In accordance with one aspect of the present disclosure, evidence base 254 may include, e.g., a model program data cluster, an organization data cluster, and/or a beneficiary data cluster.

Data associated with a model program data cluster may include, e.g., data representative of a model program, model program results, and model program result types. Data representative of model programs may include, e.g., data representative of, or otherwise associated with, one or more programs that may be associated with a particular outcome in outcome taxonomy 253 and have been scientifically studied to determine their efficacy in providing a targeted outcome. The scientific studies may include, e.g., randomized control trials, whose methods and/or results have been documented in any one or more of a plurality of different forms including, e.g., published documents, non-published documents, videos, audio lectures, articles, journals, webinars, podcasts, or the like. Model program result data may include, e.g., data that is representative of, or otherwise associated with, the quantitative and qualitative results of the scientific studies for each identified model program. Model program result type data may include, e.g., data that may be representative of, or otherwise associated with, the classes of model program results derived from the scientific studies.

Data associated with an organization data cluster may include an organization and an organization type. Organization data may include, e.g., data that may be representative of, or otherwise associated with, an organization whose model programs, model program results, and model program result types may be found within evidence base 254. Organization type data may include, e.g., data that may be representative of, or otherwise associated with, the classes of organizations that may be found in evidence base 254.

Data associated with a beneficiary data cluster may include, among other things, a beneficiary and a beneficiary type. Beneficiary data may include, e.g., data that may be representative of, or otherwise associated with, a set of markers delineating a specific population being targeted by a social program's activities. The set of markers may include, e.g., demographic and/or psychographic markers. An example of a specific population that may be targeted by a social program may include, e.g., students in grades K through 6. Beneficiary type data may include, e.g., data that may be representative of, or otherwise associated with, the classes of beneficiaries that may be found evidence base 254. Examples of classes of beneficiaries that may be found in evidence base 254 may include, e.g., students, teachers, parents, administrators, and the like.

The foregoing disclosure of the evidence base 254 sets forth an example of an evidence base that includes, e.g., a model programs data cluster, an organization data cluster, and a beneficiaries data cluster. However, the present disclosure is not so limited. Instead, any type of data cluster associated with any type of data may be built in order to facilitate the analysis of a social program including, e.g., a key characteristics data cluster.

Data collection unit 255 may be configured to obtain data that may be used to populate one or more aspects of storage unit 252 including, e.g., outcomes taxonomy 253 or evidence base 254. The data collection unit 255 may be configured to receive social program data that is to be, e.g., analyzed against outcomes taxonomy 253 and evidence base 254. Data obtained by data collection unit 255 may include, e.g., client program data, existing social program information, information associated with a new, or previously unknown, social program, information associated with new, or previously unknown, social outcome, information associated with a model program, or the like. Data collection unit 255 may obtain data in one or more of a plurality of different ways including, e.g., manual or automated upload by a client. For example, data collection unit 255 may be configured to interface with a web application utilized by the client in order to upload client program data. Client program data may include, e.g., any information or materials that a service provider may need in order to analyze the client's program. The client program data may be retrieved in response to the execution of a computer algorithm such as, e.g., a web crawler, a web spider, or the like, that may be configured to scan and extract client program data from one or more data sources accessible via network 130. The data may be retrieved in response to, e.g., a query of one or more remote data sources to identify and retrieve client program data from one or more data sources accessible via the network 130.

Data obtained via data collection unit 255 may be in any type of format including, e.g., structured or unstructured format. Obtaining, or otherwise receiving, structured data such as, e.g., client program data that may be organized via an XML schema, or the like, may have its advantages in order to simplify the analysis performed by data evaluation unit 256 that takes place to verify the integrity of the data. However, obtaining, or otherwise receiving, unstructured information such as, e.g., documents, spreadsheets, charts, diagrams, slide shows, or the like, may ensure a greater volume of data is obtained. Obtaining unstructured information may, therefore, reduce the likelihood that client program data that may relevant to the analysis of a client's program will be unintentionally omitted from the pool of information obtained, or otherwise received, by data collection unit 255.

However, the present disclosure is not in any way limited to the retrieval or receipt of client program data, nor is the present disclosure limited to obtaining client program data in accordance with the examples provided herein. Instead, for example, the data collection unit 255 may obtain any type of information including, e.g., client program data, existing social program information, information associated with a new or previously unknown social program, information associated with new or previously unknown social outcome, information associated with a model program, or the like, regardless of whether the information is structured or unstructured, in accordance with any method that may be readily apparent to one skilled in the art in light of the present disclosure.

Data evaluation unit 256 may receive data that has been obtained, or otherwise received, by data collection unit 255. The data may include, e.g., client program data. Data evaluation unit 256 may analyze the received client program data and extract, among other things, e.g., key characteristics associated with a client's program. The analysis of the received client program data may include, e.g., a review of the received client program data by a service provider staff member. The analysis of the received client program data may include, e.g., a computer algorithm running on, e.g., server 250, that may be configured to parse a batch of structured, or unstructured, client program data in order to identify and extract key characteristics of a client's program from each of the documents, files, records, reports, or the like that may be included in a batch of structured, or unstructured, client program information. The computer algorithm may be carried out by an expert system, as described herein. The expert system may be, e.g., trained by a service provider staff member. The expert system may be trained by, e.g., analyzing the historical decisions made by the service provider staff member in evaluating the received data to extract key characteristics, and adjusting weights accordingly.

Data evaluation unit 256 may facilitate a review of the integrity of data that has been obtained, or otherwise received, by data collection unit 255. Data evaluation unit 256 may evaluate the integrity of the received client program information and determine, among other things, e.g., whether the received program information relates to a single, discrete social program, as opposed to, e.g., an ambiguous collection of related programs. The received social program information may be evaluated in order to determine, among other things, e.g., that a sufficient amount of information has been received in order to describe each of the key characteristics associated with a particular program. It may be determined that a sufficient amount of information has been received by, e.g., comparing key characteristics identified as being associated with a client's program against key characteristics of model programs that may be stored, e.g., in evidence base 254. The review of the integrity of the information may be performed by, e.g., the service provider staff member. For instance, the review of the integrity of the information may be performed by an expert system that is trained to analyze the historical decisions made by a service provider staff member in evaluating the integrity of a received data set and adjust weights in the expert system.

Program rating unit 257 may facilitate the analysis and rating of key characteristics of a client's program identified by data evaluation unit 256. Program rating unit 257 may include an evaluation rubric 257A and an impact genome 257B. The analysis performed by program rating unit 257 may result in the generation of raw ratings data that may be passed to metric calculations unit 258 for transformation into one or more metrics that may be used to measure the likelihood of success of a social program.

Evaluation rubric 257A may include a discrete set of analytical dimensions against which various aspects of a program may be evaluated. The analytical dimensions associated with an evaluation rubric 257A may be static or dynamic. A static set of analytical dimensions may include, e.g., a fixed set of analytical dimensions that may be used to evaluate all social programs submitted for analysis via system 100. A dynamic set of analytical dimensions may include, e.g., a set of analytical dimensions that may be dynamically determined in response to one or more key characteristics that may be associated with a client's program. The evaluation rubric 257A may include a set of analytical dimensions that include, e.g., any mixture of static and dynamic dimensions. A set of analytical dimensions may include, e.g., proximity to beneficiary, proximity to impact, evidence, effectiveness, dosage, frequency, duration, program persistence, longitudinal effect, or the like. Any analytical dimension may be utilized that may be associated with any attribute of a client's program.

Each analytical dimension of the evaluation rubric 257A may be assigned, or otherwise associated with, a rating. The rating may be received from a service provider staff member. The rating may include, e.g., a number of the scale of 1-10. The rating may be assigned by, e.g., a service provider staff member via a user interface displaying each analytical dimension of an evaluation rubric in, e.g., a table-like format of rows and columns wherein each intersection of a row and column may facilitate the input of a rating. Each analytical dimension associated with an evaluation rubric may be displayed in association with a, e.g., a drop-down box that includes a series of numbers from 1-10. In accordance with such an aspect of the disclosure, a service provider staff member may select a rating from each respective drop-down box in accordance with the rating that is determined to be associated with each analytical dimension. A rating may be assigned to one or more analytical dimension by a computer algorithm executing via, e.g., server 250. Each analytical dimension may be rated by, e.g., identifying correlations between key characteristics of a client's program and, e.g., one or more characteristics associated with one or more model programs maintained in evidence base 254. The rating process may include analyzing historical decisions made by a service provider staff member in rating programs in accordance with an evaluation rubric and, e.g., adjusting weights in the expert system.

Each analytical dimension of a particular evaluation rubric may be assigned, or otherwise associated with, a particular weight, rank, or other scaling factor (hereinafter “scaling factor”) that may be used to appropriately scale a rating assigned to a particular analytical dimension. The scaling factor assigned to a particular analytical dimension may, among other things, e.g., define the semantic meaning inherent in the discrete points on the scale of any given analytical dimension. For example, the scaling factor may be used in order decipher the meaning of a rating of “2” that has been assigned to an analytical dimension of “proximity to beneficiary.” The scaling factor may be useful, e.g., because one or more analytical dimensions of a particular evaluation rubric 257A may be more, or less, important than another analytical dimension of the same evaluation rubric 257A.

The scaling factor for each particular analytical dimension may be static. Alternatively, or in addition, e.g., one or more weights or ranks for a particular analytical dimension may be dynamically determined. A group of scaled ratings for each analytical dimension associated with a particular evaluation rubric 257A may include, e.g., a plurality of ratings. Each of the plurality of ratings may be, e.g., associated with a particular analytical dimension. The plurality of ratings may, e.g., form a set of raw ratings data that may be passed to metrics calculations unit, described in more detail hereinbelow.

Impact genome unit 257B may include an impact genome 257B1 and a gene comparison unit 257B2. Impact genome unit 257B may facilitate the analysis and rating of a social program that may be independent of the analysis and rating performed by evaluation rubric 257A.

Impact genome 257B1 may include a database that includes a plurality of outcome genomes. Each outcome genome may be stored as a record in the impact genome. Each outcome genome may include, e.g., a genome, a unique genome identifier, a social outcome, and a level of success tag. A genome may include, e.g., a subset of genes associated with a program, or program type, that may provide the associated outcome. A gene may include, e.g., a key characteristic of a program. A unique genome identifier may include, e.g., any data string that may associate a particular social outcome with a particular outcome genome. A social outcome may include, e.g., the outcome associated with a particular outcome genome. A level of success tag may include, e.g., any data string that may provide an indication of a level of success that may be associated with a particular outcome genome. For example, the level of success tag may indicate that, e.g., a particular outcome genome is a “successful” outcome genome. Varying levels of success may be associated with an outcome genome including, e.g., unsuccessful, moderately successful, successful, or the like. Varying levels of success may be assigned, e.g., by tagging an outcome genome with a rating on a scale of 1-10. In accordance with this example a 1 may be associated with the least successful outcome genome and a 10 may be associated with the most successful outcome genome. However, the present disclosure is not so limited. Instead, for example, any data string may be used in order to associate a particular level of success with a particular outcome genome.

Each outcome genome may be created by, e.g., analyzing information stored in the evidence base 254. For example, evidence base 254 may be mined in order to create a consolidated knowledge base. The consolidated knowledge base may include, e.g., a subset of information stored in evidence base 254 that may be associated with one or more programs that produce a particular standardized outcome. The consolidated knowledge base may be analyzed in order to identify a common subset of genes that may be associated with programs that tend to produce a standardized outcome. This optimal subset of genes may be, e.g., clustered in order to define an outcome genome. This process may be repeated for each known program and standardized outcome in order fully populate an impact genome 257B 1.

While an outcome genome may typically be created by analyzing a consolidated knowledge base in order to identify a common subset of genes that may be associated with programs that tend to produce a standardized outcome, the present disclosure need not be so limited. Instead, it should be contemplated that any identifiable key characteristic that has been demonstrated to correlate to successfully produce a particular outcome may be added to the outcome genome associated with the particular outcome.

An outcome genome may be created by, e.g., a service provider staff member. For instance, an outcome genome may be created by an expert system that may be trained by, e.g., analyzing the historical decisions made by a service provider staff member in identifying an optimal subset of genes that may be associated with programs that may produce a standardized outcome and adjusting weights in the expert system.

The process for creating an outcome genome may be further illustrated by way of example. For example, evidence base 254 may be mined in order to identify a consolidated knowledge base of information that may be associated with programs that have been designed to improve literacy. The consolidated knowledge base may be analyzed in order to identify a common subset of genes associated with each literacy program. In accordance with this example, the common subset of genes for a program that improves literacy may include, e.g., early childhood intervention, direct intervention, high intensity intervention, parental engagement, small class ratio, or the like. The common subset of genes may be, e.g., clustered, associated with a particular standardized outcome (e.g., improving literacy), tagged with an outcome genome identified, and stored as an outcome genome in the impact genome 257B1. As a result, in accordance with this example, the outcome genome for a program that improves literacy may be associated with a genome that includes genes such as, e.g., early childhood intervention, direct intervention, high intensity intervention, parental engagement, small class ratio, or the like.

The evidence base 254 may be mined in order to create an outcome genome that may be associated with a level of success. For example, the evidence base 254 may be mined to identify a consolidated knowledge base of information that may be associated with programs that have been designed to produce a primary outcome. The consolidated knowledge base of information may be filtered in order to narrow the consolidated knowledge base of information to include only information associated with programs that have been identified as being “successful” at producing the primary outcome. A program may be identified as being “successful” in a plurality of different ways including, e.g., exceeding a predetermined confidence score, exceeding a predetermined number of successful outcomes, exceeding a predetermined number of success factors or the like. The filtered consolidated knowledge base may be analyzed in order to identify a common subset of genes associated with each program that has successfully produced the primary outcome. The common subset of genes may be clustered, associated with a particular standardized outcome (e.g., improving literacy), tagged with a level of success tag, tagged with an outcome genome identified, and stored as an outcome genome in the impact genome 257B1.

In the illustrative manner set forth above, system 100 may facilitate the creation of an impact genome 257B1 that may include, e.g., an outcome genome for each standardized outcome. The impact genome 257B1 may include an outcome genome that is representative of programs that are, e.g., unsuccessful at achieving an associated outcome, moderately successful at achieving an associated outcome, or successful at achieving an associated outcome.

Gene comparison unit 257B2 may be configured to analyze received program data against any one or more outcome genomes. Gene comparison unit 257B2 may be configured to receive input that includes, e.g., an outcome associated with the program and a program's key characteristic(s). Gene comparison unit 257B2 may identify a relevant outcome genome based on the received outcome. Gene comparison unit 257B2 may compare each of the key characteristics of a client's program against each gene of an outcome genome. In this manner, gene comparison unit 257B2 may determine a level of similarity between the key characteristics of a client's program and an outcome genome. Gene comparison unit 257B2 may rate the client's program against each gene of an outcome genome. Gene comparison unit 257B2 may receive one or more ratings from a service provider staff member. A rating may therefore be assigned, or otherwise associated with, each gene of an outcome genome.

Each rating may be representative of the degree to which each respective gene of the outcome genome is expressed by a client's program (hereinafter “degree of expression”). The degree of expression for each gene of the outcome genome may be, e.g., expressed as a rating from 1-10. A rating of “1” may indicate, e.g., that a particular outcome gene is not expressed by one or more key characteristics of a client's program. A rating of “10” may indicate, e.g., that a particular gene is fully expressed by one or more key characteristics. Ratings from 2-9 may be utilized, e.g., in order to convey a variance in the degree of expression between not express (e.g., 1) and fully expressed (e.g., 10). The result of the analysis performed by gene comparison unit 257B2 may, e.g., produce a plurality of ratings including, e.g., one rating for each gene of an outcome genome. The plurality of ratings may form raw ratings data that may be passed to metric calculations unit 258, described hereinbelow.

A gene of a particular outcome genome may be assigned, or otherwise associated with, a particular scaling factor that may be used to appropriately scale a rating associated with the particular gene. The scaling factor may include, e.g., a weight or rank. The scaling factor may be useful in weighing the importance of the particular gene as compared to the importance of other genes of a particular outcome genome 257B. The scaling factor for a gene may be static or dynamically determined. A group of scaled ratings for each gene associated with a particular outcome genome may form a set of raw ratings data that may be passed to metrics calculations unit, described in more detail hereinbelow.

A client program's key characteristics may, e.g., be compared to an outcome genome for a successful outcome genome. Here, the more genes of a successful outcome genome that are highly expressed in a client programs' key characteristics, the more likely it may be that a client's program may be successful. Similarly, a client's program genome may, e.g., be compared to an outcome genome for an unsuccessful outcome genome. Here, the more genes of an unsuccessful outcome genome that are highly expressed in a client programs' key characteristics, the more likely it may be that a client's program may be unsuccessful.

The gene comparison unit 257B3 may make other determinations of similarity between the key characteristics of a client's program data and a particular outcome genome that may be independent of the degree of expression rating. For example, gene comparison unit 257B3 may compare the number of genes of a successful outcome genome that may map to one or more key characteristics of a client's program. In accordance with this example, the more genes of a successful outcome genome that may be mapped to one or more key characteristics of a client's program data (e.g., without determining the degree with which each of the genes of the outcome genome are expressed in the program data), the more likely it is that a client's program may produce a successful outcome. In accordance with this aspect of the present disclosure, a client program may receive, e.g., a high rating (e.g., 10) for each gene that the client's program contains and a low rating (e.g., 1) for each gene that the client's program does not contain. Therefore, the result of this alternative analysis performed by gene comparison unit 257B2 may produce a plurality of ratings including, e.g., one rating for each gene of an outcome genome. The plurality of ratings may form raw ratings data that may similarly be passed to metric calculations unit 258, described hereinbelow.

Both evaluation rubric 257A and impact genome unit 257B may be utilized in order to analyze a social program. If both evaluation rubric 257A and impact genome unit 257B are utilized, the raw ratings data produced by each of the evaluation rubric 257A and impact genome unit 257B may be fed into metrics calculation unit 258 such that the output of each program rating unit 257A, 257B may be transformed into one or more metrics that may provide an indication of the likelihood of success of a client's program. However, nothing in this disclosure should be interpreted to place any restrictions upon the configuration of program ratings unit 257. For instance, the program ratings unit 257 may use only an evaluation rubric 257A, only an impact genome unit 258B, or both. Further, the program ratings unit may utilize other ratings methods that may readily recognized by one skilled in the art in light of the present disclosure. As a result, programs rating unit 257 may implement any ratings methodology that may be used to associate a rating with one or more aspects of a client's social program.

Metric calculations unit 258 may be configured to receive and process raw ratings data from program ratings unit 257. Metric calculations unit 258 may transform the raw ratings data into one or more metrics that may be used to measure a social program. The transformation may include processing the raw ratings data in accordance with a scaling factor. Scaling factors may include, e.g., an estimated determination of the number of success factors associated with a particular program, an estimated relative contribution of one or more success factors, an estimated confidence in the knowledge base evidence used to evaluate the program, or the like.

The transformation of the raw ratings data in accordance with one or more scaling factors may result in the generation of one or more metrics. The metrics may provide a mechanism to estimate, among other things, e.g., a likelihood of success of a social program. The metrics may include, e.g., an estimated reach of the program, an estimated number of expected successful outcomes, an estimated cost per successful outcome, and/or a confidence score. The estimated reach of a program may include, e.g., a total number of program participants. The estimated number of expected successful outcomes may include, e.g., a total number of people served by a program that are anticipated to successfully achieve the program's intended outcome. The estimated cost per successful outcome may include, e.g., an average expected cost for a program to successfully produce a single “unit” of the intended outcome. The estimated cost per successful outcome may be calculated by evaluating a ratio of the total budget for a program in comparison to the number of primary outcomes that may successfully be produced. The confidence score may include a measure of the program's efficacy. A program's efficacy may be determined by calculating, e.g., a projected likelihood that a program will achieve an intended outcome. The program's efficacy may be calculated by evaluating a ratio of the number of instances that a primary outcome is successfully produced in comparison to the program's total reach per operating cycle. The metrics generated by metric calculations unit 258 may be stored in benchmark database 259.

Alternatively, or in addition, one or more of the metrics generated by metric calculations unit 258 may be expressed in a variety of different forms including, e.g., a calculated constant numerical value, a non-calculated constant numerical value, a percentage, a confidence interval, or the like. A calculated constant numerical value may include, e.g., the number of expected successful outcomes. A non-calculated constant numerical value may include any constant that was not generated as a result of one or more transformations performed by the metric calculations unit such as, e.g., a program reach. A percentage may include a numerical representation of any ratio of two metric values or a ratio of one metric value and another calculated or non-calculated constant. A confidence interval may include an estimated range for a generated metric. For example, for an estimated number of successful outcomes, a reported successful outcomes metric may include, e.g., 1000 outcomes, +/−10%, with the +/−10% being representative of an example of a confidence interval.

Benchmark database 259 may store the results of the analysis of each social program analyzed by system 100. The data stored and maintained by benchmark database 259 may include, e.g., a program's key characteristics, raw ratings data, scaling factors, calculated metrics, the results of further analysis of the calculated metrics, or the like. Data maintained in benchmark database 259 may be queried by service provider staff, a client, or other individual in order to generate one or more reports. The reports may include, e.g., a program scorecard. The scorecard may include a snapshot of the analysis of a social program.

As noted above, analyzed social program data may be stored in benchmark database 259. This may provide system 100 with, e.g., a continuously updating stream of analyzed social program data. This analyzed social program data may include, e.g., a program's key characteristics. The program's key characteristics may be utilized to generate a program genome. The program genome may include, e.g., a genome, a unique genome identifier, a social outcome, an organization, and a level of success tag (or estimated level of success tag). Each program analyzed by system 100 may result in an identification of data that may be used to create a program genome that may be stored in benchmark database 259. The program genome may be added to one or more knowledge bases maintained by, e.g., evidence base 254, and serve as model program information for social programs that may be analyzed by system 100 in the future.

The generated program genomes may be mined in order to update the outcome genomes stored in impact genome 257B1. For example, program genomes stored in benchmark database 259 (or evidence base 254) may be mined in order to identify program genomes that were estimated to unsuccessfully produce an associated outcome, program genomes that were estimated to moderately produce an associated outcome, program genomes that were estimated to successfully produce an associated outcome, or the like. The results of such mining operations may be analyzed to identify trends in the genes that may be associated with unsuccessful, moderately successful, and successful programs, as the programs evolve over the course of time. This mining of program genomes maintained by benchmark database 259 (or evidence base 254) may be used to determine a type or genre of social programs that may be associated with a particular standardized outcome, which may have developed one or more key characteristics over time that may not have been included in a previously generated outcome genome. This mining of program genomes may be used to determine the type or genre of social programs that may be associated with a particular standardized outcome that may have begun to omit one or more key characteristics over time, which may have been included in a previously generated outcome genome. Based on the forgoing determination, one or more genes may be added to, or deleted from, one or more outcome genomes maintained in impact genome 257B 1. The continuous stream of analyzed social program data that may be added to benchmark database 259 (or evidence base 254) may therefore be used to update an impact genome 257B1.

The benchmark database 259 may, over time, accrue a wealth of information maintained for a variety of different social programs. Service provider staff or a client may access benchmark database 259 to mine and analyze the wealth of information contained, therein. For example, the service provider staff (or the client) may mine benchmark database 259 in order to compare and contrast the strengths and weaknesses of analyzed programs. The benchmark database 259 may be mined to identify, e.g., programs that have a high confidence score. A program with a high confidence score may be more likely to provide its intended outcome than a program with a low confidence score. The benchmark database 259 may be mined to identify programs based on, e.g., a cost per successful outcome. As a result, a client may be able to avail themselves of the data in benchmark database 259 in order to identify a program that the client can implement in order to produce a predetermined amount of successful outcomes in exchange for a predetermined program cost. The predetermined cost may be measured in, e.g., time, money (e.g., dollars, euros, pounds, or the like), environmental impact (e.g., generation of green-gases, carbon emissions, or the like), or the like.

FIG. 3 shows an example of a method 300 for analyzing social programs, in accordance with at least one aspect of the present disclosure. One or more steps of method 300 may be performed by, e.g., system 100.

Referring to FIGS. 2 and 3, the method 300 for analyzing a social program may begin at step 301 by, e.g., determining the benefits that a program is intended to provide. At step 302, the benefits that a program is intended to provide may be input into an outcomes taxonomy 253 in order to identify a subset of relevant outcomes associated with the program. At step 303, an evidence base 254 may be generated based, at least in part, e.g., on a survey of program information associated with a set of existing programs (or model programs). The evidence base 254 may include, e.g., a knowledge base that may be used to facilitate the analysis of a social program. The information maintained by evidence base 254 may be, e.g., organized into a plurality of data clusters, as described herein. In step 304, the subset of outcomes identified in step 302 may be used to identify a relevant set of existing programs (or model programs) that may provide the same or substantially similar outcome as the program being analyzed by method 300. Information associated with the social program may be received by data collection unit 255 at step 305. The received program information may be, e.g., uploaded by a client via a web application. The received program data may include, e.g., structured or unstructured information. At step 306, key characteristics may be extracted from the received program data. The integrity of the extracted key characteristics may be evaluated at step 307. The evaluation of the integrity of the data may include, e.g., a comparison of the key characteristics extracted from the received program information against key characteristics of one or more model programs maintained in, e.g., evidence base 254.

After the integrity of the received program information has been verified, at least a portion of the received information may be analyzed by the program ratings unit 257 at step 308 in order to generate raw ratings data. Program ratings unit 257 may analyze the received program information in accordance with the evaluation rubric 257A, as described, e.g., in accordance with method 500 shown in FIG. 5. The program ratings unit 257 may analyze the received program information in accordance with an impact genome unit 257B as described, e.g., in accordance with method 600 shown in FIG. 6.

The raw ratings data output by program ratings unit 257 may be fed into the metric calculations unit 258 at step 309. Metric calculations unit 258 may transform the received raw ratings data into one or more metrics that may facilitate a prediction of the effectiveness of a program at step 310. The effectiveness of a social program may provide a client with, among other things, e.g., an estimation of the likelihood of success of the program. The metrics may include e.g., an estimated reach of the program, an estimated number of expected successful outcomes, an estimated cost per successful outcome, and/or a confidence score. The metrics may be stored in benchmark database 259 at step 311.

At step 312, a program scorecard may be generated based at least in part on one or more metrics, or other information maintained by benchmark database 259. The scorecard may be provided to a client at step 313. The scorecard may be provided in either an electronic form or hard copy.

FIG. 4 shows an example of a program scorecard 400 in accordance with one aspect of the present disclosure. Program scorecard 400 may include, e.g., a primary outcome 410, a program description 420, an evaluation summary 430, a number of expected successful outcomes 440, a cost per outcome 450, and a confidence score (e.g., program efficacy) 460. The evaluation summary 430 may include, e.g., a scoring rubric 432, criteria for which the strength of contribution may be measured 434, a program cost 436, and a program reach 438. The scoring rubric may include categories 432a, 432b, 432c for which the strength of each criteria 434a, 434b, 434c may be displayed. The categories may include, e.g., competency 432a, internal benchmark 432b, and observations 432c. Each internal benchmark 432b may be associated with a score 432b1 and a rank 432b2. The score 432b1 may associated with, among other things, e.g., a quantitative numerical value. The rank 432b2 may be associated with, among other things, e.g., a ratings scale that includes ratings such as, e.g., below average, average, and above average. The criteria for which the strength of contribution may be measured 434 may include, e.g., a closeness of fit 434a, an evidentiary basis 434b, and a program intensity 434c.

Program scorecard 400 may be generated, e.g., in response to a query received by server 150 (shown in FIG. 1) from a service provider staff member or client. The query may, e.g., access and retrieve (or cause access and retrieval of) information maintained by one or more aspects of database(s) 160 including, e.g., benchmark database 259. The data retrieved in response to the query may be used to populate one or more fields associated with program scorecard 400. However, the present disclosure is not so limited. For example, it will be readily apparent to one skilled in the art, in light of the present disclosure, that any type of scorecard (or other report) may be generated to include any of the data that may be stored in database(s) 160 including, e.g., data stored in benchmark database 259 and evidence base 254. As a result, a service provider staff member or client may mine database(s) 160 and create a wide range of custom scorecards (or other reports).

FIG. 5 shows an example of a method 500 for using the evaluation rubric 257A (shown in FIG. 2) to rate a program, in accordance with at least one aspect of the present disclosure. One or more steps of method 500 may be performed by, e.g., system 100 (shown in FIG. 1).

Referring to FIGS. 1, 2 and 5, the method 500 begins at step 501 when program information is received by, e.g., server 150. Program information may include, e.g., client program information, existing program information, or the like. After receipt of program information, a determination may be made at step 502 regarding the predetermined number of independent rating evaluations that should be performed on a set of received program information in light of evaluation rubric 257A. The number of independent ratings evaluations that may be performed may include any real integer w (where w is a positive, non-zero integer). In accordance with at least one aspect of the disclosure, it may be, e.g., desirable to rate each program multiple times in light of one or more evaluation rubrics in order to ensure consistency of results.

At step 503, program information may be rated in light of the evaluation rubric 257A. Evaluation rubric 257A may be, e.g., a standard, static evaluation rubric or a custom, dynamically generated evaluation rubric designed for a particular outcome. At step 504, a determination is made as to whether the predetermined number of ratings evaluations have been performed. If the predetermined number of ratings evaluations have not yet been performed, the method returns to step 503 and rates the program information again in light of the evaluation rubric 257A. The evaluation rubric 257A used in subsequent rating iterations may include, e.g., the same evaluation rubric utilized in previous iterations. Alternatively, e.g., the evaluation rubric 257A used in subsequent rating iterations may include, e.g., a dynamically modified evaluation rubric that may include one or more different analytical dimensions. The dynamically modified evaluation rubric may include one or more analytical dimensions that may be associated with a different scaling factor. Such repeated evaluation of a program in light of the same or different evaluation rubric(s) may, e.g., ensure consistency and help to reduce any error or bias that may be associated with any particular evaluation rubric. If it is determined at step 504 that the predetermined number of rating evaluations have been performed, the process continues at step 505.

At step 505, the raw ratings data of each independent program evaluation may be collected. A normalization process may be applied to each set of raw ratings data associated with each program evaluation at step 506. This normalization process may, e.g., reconcile any deviation in each respective set of raw ratings data. Process 500 may conclude, e.g., at step 507 when the normalized raw ratings data is fed into metric calculations unit 258.

FIG. 6 shows an example of a method 600 for using an impact genome unit 257B to rate social programs in accordance with at least one aspect of the present disclosure. One or more steps of method 600 may be performed by, e.g., system 100.

Referring to FIGS. 1, 2 and 6, the process 600 begins at step 601 when program information is received by, e.g., server 150. Program information may include, e.g., client program information, existing program information, or the like. Program information may include, e.g., a program description and one or more program outcomes. The program outcomes may be determined using, e.g., outcomes taxonomy 253. After receipt of program information, a determination may be made at step 602 regarding the predetermined number of independent evaluations that should be performed on a set of received program information utilizing one or more outcome genomes. The number of independent ratings evaluations that may be performed may include any real integer s (where s is a positive, non-zero integer). In accordance with at least one aspect of the disclosure, it may, e.g., be desirable to rate each program multiple times in light of one or more outcome genomes in order to ensure consistency of results.

At step 603, an outcome genome may be identified. An outcome genome may be identified by, e.g., querying impact genome 257B1 to retrieve each outcome genome that may correspond to each outcome associated with the received program information. At step 604, the received program information may be compared against one or more outcome genomes. At step 606, a determination may be made regarding the degree to which each respective gene of each identified outcome genome is expressed in the program information associated with a client's program. At step 607, a determination may be made as to whether the predetermined number of evaluations has been performed. If the predetermined number of evaluations have not yet been performed, the method returns to step 605 and evaluates the program again in light of one or more outcome genomes. The outcome genome used in subsequent rating iterations may include, e.g., the same outcome genome utilized in previous iterations. Alternatively, the outcome genome used in subsequent evaluation iterations may include, e.g., an outcome genome associated with a different, yet related, outcome genome. Alternatively, or in addition, the outcome genome used in a subsequent evaluation may be associated with the same outcome but a different level of success. Alternatively, or in addition, the outcome genome utilized in a subsequent evaluation may include one or more genes that may be associated with a different scaling factor. Such repeated evaluation of a program in light of the same or different outcome genomes may, e.g., ensure consistency and help to reduce any error or bias that may be associated with any single evaluation of a program in light of a single outcome genome. If it is determined at step 607 that the predetermined number of rating evaluations have been performed, the process continues at step 608.

At step 608, the raw ratings data of each independent program evaluation may be collected. A normalization process may be applied to each set of raw ratings data associated with each program evaluation at step 609. This normalization process may, e.g., reconcile any deviation in each respective set of raw ratings data. Process 600 may conclude, e.g., at step 610 when the normalized raw ratings data is fed into metric calculations unit 258.

FIG. 7 shows an example of a method 700 for updating an impact genome in accordance with at least one aspect of the present disclosure. One or more steps of method 700 may be performed by, e.g., system 100.

Referring to FIGS. 1, 2 and 7, the process 700 begins at step 701 with the evaluation of a benchmark database 259 (or evidence base 254) in order to, e.g., identify a subset of program genomes associated with a particular outcome and/or a particular level of success. The subset of program genomes may be identified by, e.g., mining benchmark database 259 (or evidence base 254). The performance of step 701 may, e.g., identify all program genomes associated with the outcome “improving literacy” that have been estimated to exceed a predetermined threshold of “successful” primary outcomes.

At step 702, the identified subset of programs may be analyzed to determine a common subset of genes associated with each of the programs in the identified subset of programs. At step 703, the common subset of genes may be clustered to form an updated outcome genome. At step 704, a previously generated outcome genome may be obtained. The previously generated outcome that is obtained may be associated with the same primary outcome as the updated outcome genome.

At step 705, each gene of the updated outcome genome may be compared to each gene of a previously generated outcome genome that may be stored, e.g., in impact genome 257B 1. The previously generated outcome genome may be modified based, at least in part, on the comparison between the updated outcome genome and the previously generated outcome genome at step 706. The step of modifying may include, e.g., adding one or more genes of the updated outcome genome to the previously generated outcome genome. Alternatively, or in addition, the step of modifying may include, e.g., deleting one or more genes of the previously generated outcome genome that were not found in the updated outcome genome.

Process 700 may conclude at step 707 when the modified outcome genome is stored in the impact genome 257B1. The modified outcome genome may, e.g., replace the previously stored outcome genome.

FIG. 8 shows an example of a system 800 for mining a benchmark database 859 in accordance with an aspect of the present disclosure. System 800 may include a client computer 820, a network 130, communication links 140, and a server 850.

Client computer 820 may be substantially the same as, or similar to, e.g., service provider staff computer 110 in FIG. 1. Alternatively, client computer 820 may be substantially the same as, or similar to client computer 120 in FIG. 1. In addition to the features set forth with respect to service provider staff computer 110 and client computer 120, client computer 820 may also provide a service provider staff member or client access to, e.g., web application 826. Web application 826 may be substantially the same as, or different than, other web applications described herein. In addition, web application 826 may facilitate access to, and the mining thereof, benchmark database 859.

Server 850 may be substantially the same as, or similar to server 250 shown in FIG. 2. The central processing unit 851, storage unit 852, outcomes taxonomy 853, evidence base 854, data collection unit 855, data evaluation unit 856, program rating unit 857, evaluation rubric 857A, impact genome 857B, metric calculations unit 858, and benchmark database 859 may be substantially the same as, or similar to the central processing unit 251, storage unit 252, outcomes taxonomy 253, evidence base 254, data collection unit 255, data evaluation unit 256, program rating unit 257, evaluation rubric 257A, impact genome 257B, metric calculations unit 258, and benchmark database 259, respectively, shown in FIG. 2 and described herein.

Over time, as programs are analyzed using the system 100, and one or more metrics are generated and stored for each analyzed program in, e.g., benchmark database 259, troves of information may be generated, which may be stored in, and maintained by, benchmark database 859. The information maintained by benchmark database 859 may include, e.g., a cost per outcome for all client programs, model programs, and any other social program that may be known and analyzed. As a result, the information maintained by benchmark database 859 may include, e.g., the cost per outcome associated with every identified program outcome 960.

The cost per outcome associated with an identified program may be determined by analyzing benchmark data maintained by benchmark database 859. For example, benchmark database 859 may be accessed using web application 826 and mined to determine the number of successful outcomes produced by each identified program that may be associated with the outcome. Similarly, benchmark database 859 may be mined, e.g., in order to determine the cost (e.g., time, money, environmental impact, or the like) associated with each identified program. Comparing the number of successful outcomes produce by each program with the cost of each program may yield, e.g., the cost per outcome for a program outcome.

The benchmark data may be made accessible to a client to facilitate effective and efficient organizational planning. For example, a client may, e.g., utilize web application 826 to query benchmark database in order to retrieve benchmark data. Server 850 may, e.g., receive the query, identify benchmark data that satisfies the parameter(s) of the query, and provide client computer 820 with benchmark data that satisfies the query request(s).

For example, a client may submit a query that requests the identification and return of benchmark data that may be representative of, e.g., the cost per program for one or more outcomes. In response to the query, server 850 may provide the cost per outcome for each of the one or more outcomes to client computer 820 such that the cost per outcome of different programs may be compared, or otherwise evaluated.

For example, using system 800, a client may submit a query requesting the cost per outcome for jobs created in every state in the United States of America. A client may receive, e.g., a cost per outcome for jobs created in every state in the United States, which may be provided on a state-by-state basis from server 850. In this example, the received information regarding each state's job creation program may be analyzed in order to determine the most cost effective outcome for creating jobs.

The benchmark database 859 may be mined periodically in order to compare programs associated with the same, or similar outcomes, and determine what may be the most cost effective program for any given outcome. The most cost effective programs may include, e.g., the program that achieves an outcome that is desired by a client at the lowest cost per outcome.

The system 800 may utilize benchmark data to facilitate the predictive analysis of the impact of a program. Server 850 may receive a request that includes, e.g., an intended outcome and an amount of money that a client plans to invest in the intended outcome. Server 850 may process the request in order to determine, among other things, e.g., the kind of return that the client may receive on the planned investment. Such an analysis may include, e.g., an analysis of a reach of a program, cost per outcome, effectiveness of the program, an estimated profit per outcome, or the like.

For example, a scenario may arise wherein a non-profit agency has a budget of $1,000,000 to spend on a program that increases literacy. The non-profit organization, e.g., utilizing a client computer 820, may submit a query request that includes a desired outcome of “increasing literacy” and a budget of “$1,000,000. The query may be received by, e.g., server 250 and the benchmark database 859 may be mined using the received outcome and budget data for programs that have provided a primary outcome of “increasing literacy.” These programs may be analyzed to determine, e.g., a cost per successful outcome associated with each program that has provided the primary outcome of “increasing literacy.” These results may then be further processed in order to, e.g., sort and filter the search results, for the purposes of identifying the program, or program characteristics (e.g., program genome), that may provide the most successful outcomes for the non-profits budget. In the example herein, e.g., each outcome may be representative of each student who is expected to reap increased literacy skills as a result of the program.

In accordance with another aspect of the present disclosure, system 800 may facilitate performing predictive modeling of the impact of a program. Server 850 may, e.g., receive a plurality of one or more program elements that may be associated with a program. The program elements may include, e.g., one or more key characteristics associated with a program. In response to the receipt of one or more program elements, server 850 may, e.g., calculate a program's expected outcome. A program's outcome may be calculated by, e.g., analyzing the key characteristics in view of outcomes taxonomy 253, 853. Alternatively, or in addition, the program's outcome may be calculated by, e.g., comparing each of the received program elements to each gene associated with each outcome genome that may be maintained, e.g., by impact genome 257B1, 857B1. If, e.g., there is determined to be a sufficient correlation between the received genes and the genes associated with an outcome genome, then server 850 may determine, e.g., that the program associated with the received genes may produce the same, or similar, outcome that may be associated with the outcome genome.

In accordance with yet another aspect of the present disclosure, system 800 may be configured to facilitate grant matching. In grant matching, the system may, e.g., facilitate the matching of a desired outcome with an organization that may best achieve the desired outcome.

For example, service provider staff may, e.g., create, provide, or obtain, a universal grant application that may be stored on server 850 and accessible by a client 820 via the network 130 and communication link 140. Client 820 may, e.g., populate the fields of the universal grant application and transmit the populated universal grant application to server 850. Client 820 may include, e.g., a small business, a corporation, a non-profit organization, a government agency, or any other entity. The populated universal grant application may include on or more key characteristics associated with the entity. Key characteristics that may be associated with an entity may be the same as, or similar to the key characteristics that may be associated with a program. Alternatively, or in addition, an entity's key characteristics may include, e.g., any attribute associated with an entity including, e.g., an entity's mission statement (or other goals), beneficiaries, staff size, geographic location, budget, or the like. Server 850 may utilize, e.g., outcomes taxonomy 853 in order to filter the grant applications in order to identify a subset of one or more outcomes that may best suit a client's key characteristics.

FIG. 9 shows an example of a system 900 for facilitating an outcomes marketplace 960 in accordance with one aspect of the present disclosure. System 900 may include a client computer 920, the network 130, the communication link 140, and a server 950.

Client computer 920 may be substantially the same as or similar to, e.g., service provider staff computer 110 in FIG. 1. Alternatively, client computer 920 may be substantially the same as or similar to client computer 120 in FIG. 1.

In addition to the features set forth with respect to service provider staff computer 110 and client computer 120, client computer 920 may also provide a service provider staff member or client with access to, e.g., web application 926. Web application 926 may be the same as, or different than, other web applications described herein including, e.g., web application 826. In addition, web application 926 may facilitate access to, and the interaction with, outcomes marketplace 960. Via web application 926, the client may put out a market “call” for an outcome, receive outcome price information, bid on an outcome, receive confirmation of a purchase or sale of an outcome, or any other functionality that may be associated with the trading of an outcome via outcomes marketplace 960.

Server 950 may be, e.g., substantially the same as, or similar to server 250 shown in FIG. 2. The central processing unit 951, storage unit 952, outcomes taxonomy 953, evidence base 954, data collection unit 955, data evaluation unit 956, program rating unit 957, evaluation rubric 957A, impact genome 957B, metric calculations unit 958, and benchmark database 959 may be substantially the same as, or similar to the central processing unit 251, storage unit 252, outcomes taxonomy 253, evidence base 254, data collection unit 255, data evaluation unit 256, program rating unit 257, evaluation rubric 257A, impact genome 257B, metric calculations unit 258, and benchmark database 259, respectively, shown in FIG. 2.

Server 950 may also include, e.g., an outcomes marketplace 960. Outcomes marketplace 960 may include an operational market where, e.g., buyers and sellers may access an online exchange to buy and sell program outcomes. Program outcomes may include, e.g., social outcomes. Buyers and sellers may access outcomes market place via a web application 926 that may be accessible from a client computer 920. Outcomes marketplace 960 may function as any type of market including, e.g., a call market, an auction market, or any other kind of market.

In accordance with one aspect of the present disclosure, outcomes market place 960 may be, e.g., a call market. For example, an individual who desires to achieve a particular outcome may utilize web application 926 to submit a call for the particular outcome to the outcomes market place 960 via network 130 and communication link 140. For example, an individual could put out a call for an outcome such as, e.g., the creation of 1,000 inner city youth jobs. Outcomes marketplace 960 may receive the call request and generate a listing in the online exchange to facilitate review and consideration of the call option by one or more prospective buyers. An online exchange listing may provide a display that includes, e.g., a benchmark price, a current price, bids, bidder identification information, seller identification information or the like. Alternatively, or in addition, an online exchange listing may include any subset of benchmark data associated with a particular outcome that may be obtained by mining benchmark database 1059. Bidders may include, e.g., small businesses, corporations, non-profits, government agencies, or any other entity that may be interested in obtaining a particular outcome. Outcomes marketplace 960 may then facilitate the execution of the trade at the requisite time. The execution time of the trade may be specified by, e.g., the call request.

Web application 926 may facilitate any necessary tasks required to interact with outcomes marketplace 960. For example, web application 926 may provide, among other things, e.g., a graphical user interface. In addition to the support of the necessary functions of submitting call requests and bidding on outcomes that may be placed in the market for sale, web application 926 may facilitate, e.g., the submission of a query for outcomes that are being sold by outcomes marketplace 960. Outcomes marketplace 960 may, e.g., receive a query for an outcome, identify any online exchange listings associated with parameters specified by the query, and provide each of the online exchange listings to web application 926 that may satisfy the parameters of the query.

Alternatively, or in addition, outcomes marketplace 960 may be configured to support, e.g., the purchase of and/or investment in an outcome derivative product. An outcome derivative product may include, e.g., a predetermined package of one or more outcomes that may be purchased by a client. An outcome derivative product may be created by, e.g., one or more service provider staff members. An outcome derivative product may be further described by way of the following example.

In accordance with one aspect of the present disclosure, a service provider staff member may mine database 160 (shown in FIG. 1), which may include, e.g., benchmark database 959 (and/or evidence base 954) in order to obtain information associated with one or more programs in order to create a derivative product. For example, a service provider may mine database 959 (or evidence base 954) in order to create an outcomes derivative product for the purpose of creating inner city jobs. The information obtained from benchmark database 959 (or evidence base 954) may include, e.g., one or more outcomes and one or more metrics. The mining results may include a plurality of outcomes that may be associated with an inner city jobs derivative product including, e.g., increasing low wage jobs, increasing youth jobs, increasing tech sector jobs, or the like. Alternatively, or in addition, the mining results may include, e.g., an efficacy, a program reach, and/or a cost per successful outcome for each outcome. Based on the received outcomes and metrics, e.g., the cost required to produce a single unit of each particular outcome may be determined. In accordance with the example set forth herein, the inner city job financial derivative product may be associated with a particular cost (e.g., in dollars, euros, pounds, etc.) per each low wage job (e.g., $5,000 per low wage job), each youth job (e.g., $8,000), and/or each tech sector job (e.g., $20,000), respectively.

Any outcome derivative product may be created applying the principles of the disclosure, including a grouping of outcomes that may serve to attract investment by one or more clients. For instance, a plurality of outcome derivative products may be generated by a service provider and stored, e.g., in an outcomes market place database that may be associated with outcomes marketplace 960.

A client 920 may utilize a web application 926 in order to, e.g., access outcomes marketplace 960. Client 920 may, e.g., submit a query via web application 926 in order to search an outcomes marketplace database that may include, e.g., a plurality of outcome derivative products. Outcome marketplace 960 may receive the query, identify a plurality of one or more outcome derivative products that satisfy the parameters of the query, and provide a plurality of one or more outcome derivative products to a client 920.

A client may determine to invest, e.g., $1,000,000 in an inner city job outcome derivative product. The investment may be, e.g., divided amongst each of the plurality of outcomes associated with the inner city job outcome derivative product. The investment may be divided, e.g., evenly amongst each of the plurality of outcomes associated with the inner city jobs outcome derivative product. Alternatively, e.g., the investment may be divided amongst each of plurality of outcomes associated with the inner city jobs outcome derivative product based on, e.g., a predetermined tiered percentage that may be associated with each outcome (e.g., 50% to a first outcome, 25% to a second outcome, and 25% to a third outcome). The predetermined tiered percentage may be determined by, e.g., a service provider staff member or the client. The client may submit the investment to, e.g., the service provider.

Upon receipt of the investment, the service provider may provide the investor with the outcome genome, or key characteristics that may be associated with successful outcomes purchased by the client. The client may then, e.g., implement a program that is in accordance with the received outcome genome. In accordance with the example set forth herein, and assuming, e.g., an even distribution of the client's initial investment, a client would be assured of receiving a program that may be capable of creating 66 low wage jobs, 41 youth jobs, and 16 tech sector jobs. Such units of outcome may be accurately predicted based, at least in part, on the metrics maintained for each known program in, e.g., benchmark database 959, including, e.g., a program's efficacy, a program's reach, and a program's cost per successful outcome.

Alternatively, or in addition, a service provider may, e.g., take steps to ensure that one or more outcomes purchased as part of an outcomes derivative product are implemented. For example, upon receiving an investment from a client, the service provider may disburse the received investment to one or more entities that may be best suited to achieve the outcomes purchased by the client. An entity that is best suited to achieve an outcome purchased by the client may be determined, e.g., by implementing a process that is the same, or similar to, the grant matching process described herein above.

Alternatively, e.g., a service provider may create a financial derivative product that is designed to achieve a particular outcome. For example, service provider may mine benchmark database 959 in order to determine one or more outcomes that may be arranged in a particular outcome derivative product in order to create, e.g., 1000 jobs. The service provider may determine, based at least in part, e.g., on one or more metrics such as, e.g., the efficacy of a program, the reach of a program, and cost per successful primary outcome of the program, how much it would cost to create 1000 jobs. The service provider may set a price for the outcomes derivative product. A client may, e.g., submit an investment to the service provider that is equivalent to the price set by the service provider. The service provider may, e.g., disburse the investment to each program associated with each of the outcomes associated with a respective outcome derivative product.

While the disclosure has been described in terms of exemplary embodiments, those skilled in the art will recognize that the disclosure can be practiced with modifications that fall within the spirit and scope of the appended claims. These examples given above are merely illustrative and are not meant to be an exhaustive list of all possible designs, embodiments, applications or modification of the disclosure.

What is claimed is:

1. A method for analyzing a program, the method comprising:
receiving program information;
identifying an outcome genome associated with the program information;
comparing the received program information against the identified outcome genome, wherein the outcome genome includes a plurality of genes; and,
generating raw ratings data, wherein the raw ratings data includes a plurality of ratings, wherein each rating in the plurality of ratings corresponds to a relationship between each of the plurality of genes and the received program information.

2. The method of claim 1, wherein a gene includes a key characteristic associated with an outcome.

3. The method of claim 1, wherein the relationship between a gene and the received program information includes a measure of the degree that the gene is expressed in the program information.

4. The method of claim 1, wherein the received program information comprises:
one or more key characteristics associated with the program; and,
one or more outcomes associated with the program.

5. The method of claim 4, wherein the step of identifying an outcome genome further comprises:
querying an impact genome database to retrieve each outcome genome corresponding to each of the one or more outcomes associated with the program.

6. The method of claim 1, wherein the outcome genome is associated with a level of success tag.

7. The method of claim 6, wherein the level of success tag provides an indication that the outcome genome is associated with one of a successful, moderately successful, or unsuccessful outcome.

8. The method of claim 1, the method further comprising:
feeding the raw ratings data into a metric calculations unit.

9. The method of claim 8, the method further comprising:
transforming the raw ratings data into one or more metrics by processing the raw ratings data in accordance with one or more scaling factors.

10. The method of claim 9, wherein the one or more metrics include at least one of an estimated number of outcomes, an estimated cost per outcome, or a confidence score.

11. A system for analyzing a program, the system comprising:
a service that includes:
a central processing unit, and
a storage unit, wherein the storage unit further comprises:
an outcomes taxonomy;
an evidence base; and,
an impact genome unit, wherein the impact genome unit further comprises:
a receiving module that receives program information;
a gene comparison module that compares the received program information to an outcome genome; and,
a ratings module that generates raw ratings data, wherein the raw ratings data includes a plurality of ratings, wherein each rating in the plurality of ratings corresponds to a relationship between each of the plurality of genes and the received program.

12. The system of claim 11, wherein a gene includes a key characteristic associated with an outcome.

13. The system of claim 11, wherein the relationship between a gene and the received program information includes a measure of the degree that the gene is expressed in the program information.

14. The system of claim 11, wherein the received program information comprises:
one or more key characteristics associated with the program; and,
one or more outcomes associated with the program.

15. The system of claim 11, wherein the system further comprises:
a querying unit that queries an impact genome database to retrieve each outcome genome corresponding to each of the one or more outcomes associated with the program.

16. The system of claim 11, wherein the outcome genome is associated with a level of success tag.

17. The system of claim 16, wherein the level of success tag provides an indication that the outcome genome is associated with one of a successful, moderately successful, or unsuccessful outcome.

18. The system of claim 11, the system further comprising:
a metric calculation unit that receives raw ratings data.

19. The system of claim 18, the system further comprising:
a metric calculation unit that transforms raw ratings data into one or more metrics by processing the raw ratings data in accordance with one or more scaling factors.

20. The system of claim 19, wherein the one or more metrics include at least one of an estimated number of outcomes, an estimated cost per outcome, or a confidence score.
